(19) United States
(12) Patent Application Publication
(10) Pub. No.: US 2018/0029288 A1
(43) Pub. Date: Feb. 1, 2018

(54) PROCESS FOR PRODUCING STRUCTURED POLYMER SURFACES

(71) Applicant: BASF SE, Ludwigshafen (DE)

(72) Inventors: Bernhard VON VACANO, Tarrytown, NY (US); Bernd BRUCHMANN, Freinsheim (DE); Robert HUBER, Limburgerhof (DE); Maik NOWAK, Ludwigshafen (DE); Achim BESSER, Ludwigshafen (DE); Harald KRÖGER, Boehl-Iggelheim (DE); Jürgen RUEHE, Eichstetten am Kaiserstuhl (DE); Mara FLOREA, Freiburg (DE)

(21) Appl. No.: 15/551,080

(22) PCT Filed: Feb. 8, 2016
(86) PCT No.: PCT/EP2016/052633

§ 371 Date: Aug. 15, 2017

(30) Foreign Application Priority Data
Feb. 16, 2015 (EP) 15155185.0

(51) Int. Cl. B29C 59/02; B08B 17/00

(52) U.S. Cl. CPC B29C 59/025; B08B 17/00; B29C 2059/023; B29K 2995/0093

(57) ABSTRACT

The invention relates to a process for the production of a structured surface on a polymeric material. In the production process, the polymeric material is brought into contact with a surface-structuring mold which comprises, on a first side, channels of length at least 10 μm, open toward the first side, and then the removal of the surface-structuring mold from the polymeric material, where the structured surface is obtained on the polymeric material. The polymeric material is brought into contact with the surface-structuring mold at ambient pressure.

The invention relates to a process for the production of a structured surface on a polymeric material. In the production process, the polymeric material is brought into contact with a surface-structuring mold which comprises, on a first side, channels of length at least 10 μm, open toward the first side, and then the removal of the surface-structuring mold from the polymeric material, where the structured surface is obtained on the polymeric material. The polymeric material is brought into contact with the surface-structuring mold at ambient pressure.

During the course of recent years, liquid-repellent surfaces have achieved increasing importance for high-performance materials, in particular for self-cleaning materials in the field of the construction industry and packaging industry, in textiles, and also in the field of medical products and of household items. Particularly important surfaces here are those which are water-repellent (hydrophobic) and oil-repellent (oleophobic).

Various processes for the production of liquid-repellent surfaces of this type involving polymers have been described in the prior art, their basis being that the surfaces are inherently hydrophobically or oleophobically modified, in that they are by way of example covered with a hydrophobic or oleophobic polymer film. It is moreover possible that the surface is inherently hydrophobically or oleophobically modified and functionalized by low-molecular-weight compounds, for example by silanes or fluorinated hydrocarbons. Another possibility is to alter the structure of the surface in the micrometer range or nanometer range, for example via structuring or roughening of the surface. Combinations of the two methods are, of course, also possible.

There are various processes described in the prior art for modifying the structure of the surface of the polymers.

S.-H. Hsu and W. M. Sigmund, Langmuir 2010, 26 (3), 1504-1506, describe a process for the structuring of surfaces on polymeric materials, in which a polymeric material is brought into contact in vacuo for ten minutes with a porous membrane between two glass supports. The glass supports serve to press the polymeric material onto the porous membrane. The porous membrane is then pulled away from the polymeric material in order to obtain the structured surface on the polymeric material. The structured surface generally has acicular or crinite structuring. The process described has the disadvantage that the arrangement of apparatus is extremely complicated. The need to operate in vacuo, and the simultaneous pressing of the polymeric material with the porous membrane by the glass supports also render the process described time-consuming and expensive. The structured surfaces obtained in said process in essence correspond to a one-to-one replication of the membrane used. The process described therefore gives relatively small length-to-diameter ratios of the resultant acicular or crinite structuring, and this has an adverse effect on the water-repellent properties of the polymeric materials thus produced.

US 2013/0230695 describes a similar process in which crinite structured surfaces are likewise produced on polymeric materials. In the process described in US 2013/0230695 a porous membrane is likewise placed onto a polymeric material, and then treated in vacuo between two glass plates under pressure for ten minutes. Finally, the porous membrane is pulled away from the polymeric material, or selectively dissolved by solvent, and the structured surface is thus obtained on the polymeric material. Again in the structuring produced as in US 2013/0230695 the ratio of the length to the diameter of the tiny hairs is relatively small, and moreover only short needles or tiny hairs are obtained, the water-repellent effect of which is therefore only small. The arrangement of apparatus in the process described in US 2013/0230695 is moreover also extremely complicated, and time-consuming and expensive, since it is essential to operate in vacuo and to press the porous membrane with the polymeric materials and the two glass plates.

H. E. Jeong et al., Nano Lett. 2006, 6, 1508-1513, describes a process for the production of structured surfaces of polymeric materials, where the surface is structured to give tiny hairs. This process applies a mold, one side of which is non-porous, to the polymeric material in vacuo, and the structured surface is obtained by bringing the mold away from the polymeric material after heating for at least one hour. This process also has the disadvantage that it is likewise essential to operate in vacua.

J. Fang, Macromol. Mater. Eng. 2010, 295, 859-864 likewise describes a process for the production of structured surfaces on polymeric materials. The structuring is achieved via an etched metal mold, the depth of the structures of which is about 2 μm. The metal mold is applied under pressure to the polymeric material, and then pulled away. This process forms structured surfaces, but these do not have crinite structuring. This process requires strong adhesion or physical grip between molten polymer and the rough mold, since this has only very small depth and few undercuts. This makes the process susceptible to phenomena that reduce adhesion, for example resulting from polymer residues that remain behind and can adversely affect the rough surface with its small depth. The effect may moreover be reduced by an increase in the concentration of adhesion-reducing substances, for example release agents or lubricant additives which are regularly added as processing aids in industrial plastics. Complicated cleaning between operations is therefore necessary, and the service time of the template is reduced.

D. Y. Lee et al., Soft Matter 2012, 8, 4905-4910 likewise describes a process for the production of structured surfaces on polymeric materials. In this process the polymeric material is applied to a structuring mold made of aluminum oxide and non-porous on one side, and is then heated for a period of about three hours. The structuring mold comprises channels which are used for the structuring of the surface of the polymeric material. The structuring mold is then removed from the polymeric film by etching, or is pulled away. It is necessary to modify the surface of the structuring mold before use so that it can be pulled away. This makes the process extremely time-consuming and expensive. The structured surfaces produced by the process described have a structure of tiny hairs where the length and diameter of the tiny hairs is in essence the same as the length and diameter of the channels of the structuring mold. The tiny hairs on the structured surface therefore have relatively small length:diameter ratios.

DE 10 2013 109 621 likewise describes a process for the production of structured surfaces on polymeric materials. An assembly is provided of a first plate and a second plate which is a polymer plate. A third plate is subsequently heated to a temperature of above the glass transition temperature of the polymer of the second plate, and is pressed onto the second plate. The third plate is subsequently removed again, forming tiny hairs on the surface of the second plate. A disadvantage of the process described in DE 10 2013 109 621 is that precise prediction of the arrangement, length, number and diameter of the tiny hairs is not possible. It is therefore impossible to predict with precision the water-repellency properties of the structured surfaces. As a result, the surface properties of the polymeric materials cannot be reliably reproduced.

DE 10 2008 057 346 likewise describes the production of structured surfaces on polymeric materials. It uses a chemically etched matrix which on the surface has a micrometer-sized terrace structure and a nanometer-sized groove structure. A polymeric material is pressed onto this surface, under pressure and at temperature, in order to impress the structuring. This process necessitates the strong adhesion or hooked engagement by melted polymer to the rough mold, since the latter has only a very low depth and little undercutting. As a result, the process is susceptible to adhesion-reducing processes, as a result of polymer residues, for example, which may remain and may fill up the rough surface with the low depth. As a result, when the etched matrix is used more than once, the polymeric materials have only a weakly structured surface and therefore exhibit weak water-repellency properties.

It was therefore an object of the present invention to provide a process for the production of structured surfaces on polymeric materials which does not have the disadvantages described above of the processes described in the prior art, or has these to a reduced extent. A particular intention is that the process can be carried out simply and at low cost.

Said object is achieved via a process for producing a structured surface of a polymeric material by a surface-structuring mold which comprises a first side and a second side, where the first side of the surface-structuring mold comprises channels of length at least 10 μm open toward the first side, comprising the steps of:
i) provision of the polymeric material,
ii) bringing the polymeric material provided in step i) into contact with the first side of the surface-structuring mold,
iii) removal of the surface-structuring mold from the polymeric material to give a structured surface on the polymeric material,

where the step ii) is carried out at ambient pressure.

The resultant structured surfaces on the polymeric material have very high hydrophobicity.

The structured surfaces can moreover comprise tiny hairs, the length, diameter, and shape of which can be adjusted with precision via the process of the invention. The process of the invention can moreover be carried out very rapidly and thus at extremely low cost, in particular because one embodiment of the invention operates with an application preferably in the range from only 0 to 25 kPa, and moreover because the polymeric material is brought into contact with the surface-structuring mold at ambient pressure. The procedure is therefore also suitable for a continuous process, for example a roll-to-roll process.

The process of the invention is explained in more detail below.

In the process of the invention a surface of a polymeric material is structured by a surface-structuring mold.

A suitable polymeric material is any of the polymeric materials known to the person skilled in the art. It is preferable that the polymeric material is a polymeric film or a polymeric sheet, particularly preferably a polymeric film. For the purposes of the present invention, the expression “polymeric sheet” means a polymeric material of thickness in a range from >1 mm to 100 mm. The expression “polymeric film” means a polymeric material of thickness in the range from 30 μm to 1 mm, preferably in the range from 50 μm to 500 μm.

The thickness of the polymeric material is usually in the range from 30 μm to 100 mm, preferably in the range from 30 μm to 10 mm, and with particular preference in the range from 50 μm to 1 mm.

The present invention therefore also provides a process in which the thickness of the polymeric material provided in step i) is in the range from 30 μm to 100 mm.

The polymeric material comprises at least one polymer. The polymeric material can comprise precisely one polymer. It is equally possible that the polymeric material comprises two or more polymers. If the polymeric material comprises two or more polymers, these can by way of example take the form of homogeneous mixture in the polymeric material. It is equally possible that the two or more polymers in the polymeric material take the form of composite materials, i.e. by way of example take the form of layers. Composite materials of this type are known to the person skilled in the art.

Polymers suitable as the at least one polymer comprised in the polymeric material are any of the polymers known to the person skilled in the art that are thermoplastically processible. The at least one polymer is by way of example selected from the group consisting of amorphous, semicrystalline, and crystalline thermoplastically processible polymers. It is preferable that at least one polymer comprised in the polymeric material is selected from the group consisting of amorphous and semicrystalline thermoplastically processible polymers.

The at least one polymer comprised in the polymeric material usually has a glass transition temperature T_{G}. The glass transition temperature T_{G} is by way of example in the range from −50 to 250° C., preferably in the range from −20 to 200° C., and with particular preference in the range from −10 to 180° C., determined by differential scanning calorimetry (DSC) in accordance with ISO 11357-2.

Methods for determining the glass transition temperature T_{G} by differential scanning calorimetry (DSC) are known per se to the person skilled in the art.

The expression “glass transition temperature T_{G}” means the temperature at which the at least one polymer, when cooled, solidifies to give a glassy solid.

The at least one polymer comprised in the polymeric material has a melting point T_{M} if the at least one polymer is a semicrystalline or crystalline thermoplastically processible polymer. The melting point T_{M} of the at least one polymer is then usually in the range from 40 to 400° C., preferably in the range from 60 to 300° C., and with particular preference in the range from 80 to 250° C., determined by differential scanning calorimetry (DSC).

The expression “melting point T_{M}” of the polymer means the temperature at which the crystalline fraction of a semicrystalline or crystalline polymer changes entirely from the solid physical state to a liquid physical state, and the entire polymer therefore takes the form of homogeneous melt.

It is clear to the person skilled in the art that in the case of an amorphous polymer the melting point T_{M} of the polymer is equal to the glass transition temperature T_{G} of the polymer.

In one embodiment of the present invention, the at least one polymer comprised in the polymeric material is selected from the group consisting of polyolefins, polystyrene, polystyrene/maleic anhydride copolymers, polyacrylonitrile, polyvinyl chloride, polyvinylidene chloride, polyvinylidene fluoride, polytetrafluoroethylene, polybutadiene, polyisoprene, polyacrylates, polymethacrylates, acrylate copolymers, methacrylate copolymers, polyesters, polyoxymethylene, polyamides, polyim ides, polyurethanes, polycarbonates, polyether ketones, polyether sulfones, copolymers thereof, and mixtures thereof.

Examples of suitable polyolefins are polyethylene and polypropylene, and also copolymers of these.

Suitable polyacrylates and polymethacrylates are produced from monomeric acrylates and methacrylates, for example methyl acrylate, ethyl acrylate, propyl acrylate, butyl acrylate, or methyl methacrylate.

Acrylate copolymers and methacrylate copolymers are preferably copolymers of acrylates or methacrylates with other acrylates or methacrylates or styrene, acrylonitrile, vinyl ethers, or maleic anhydride.

Examples of suitable polyesters are polyethylene terephthalate and polybutylene terephthalate, polyhydroxybutyrate, polylactide, and cellulose acetate.

In one preferred embodiment the at least one polymer comprised in the polymeric material is selected from the group consisting of polyethylene, polypropylene, polystyrene, copolymers of polystyrene, polyesters, polyamides, polycarbonates, and polyurethanes.

The present invention therefore provides a process in which the polymeric material comprises at least one polymer selected from the group consisting of polyethylene, polypropylene, polystyrene, copolymers of polystyrene, polyesters, polyamides, polycarbonates, and polyurethane.

In an embodiment to which particular preference is given, the polymeric material is a polymeric film which comprises, as the at least one polymer, a polyolefin.

Surface-Structuring Mold

The surface-structuring mold in the invention comprises a first side and a second side. The surface-structuring mold can moreover comprise other sides.

It is preferable that the first side of the surface-structuring mold is opposite to the second side of the surface-structuring mold, and in particular it is preferable that the first side of the surface-structuring mold and the second side of the surface-structuring mold are parallel to one another.

The present invention therefore also provides a process in which the first side of the surface-structuring mold is opposite to the second side of the surface-structuring mold.

For the purposes of the present invention, if the first side of the surface-structuring mold is opposite to the second side of the surface-structuring mold, this means that the first side is spatially opposite to the second side. The first side of the surface-structuring mold can then be parallel or not parallel to the second side of the surface-structuring mold, it being preferably parallel.

For the purposes of the present invention, the expression surface-structuring mold means that the surface of the surface-structuring mold modifies only the surface of the polymeric material. The surface-structuring mold does not alter the remainder of the shape of the polymeric material. The thickness of the surface-structuring mold is then by way of example in the range from 10 μm to 1 mm, and preferably in the range from 15 μm to 500 μm.

A suitable surface-structuring mold is any of the surface-structuring molds known to the person skilled in the art. The surface-structuring mold can by way of example take the form of ram, roller, cylinder, or belt. Equally it is possible that the surface-structuring mold has been applied to a ram, a roller, a cylinder, or a belt. If the surface-structuring mold has been applied to a ram, a roller, a cylinder, or a belt, the second side of the surface-structuring mold faces toward the ram, the roller, the cylinder, or the belt. Correspondingly, the first side faces away from the ram, the roller, the cylinder, or the belt.

The first side of the surface-structuring mold in the invention comprises channels of length at least 10 μm open toward the first side.

For the purposes of the present invention, the expression “open toward the first side” means that fluids can penetrate from the first side of the surface-structuring mold into the channels.

In one preferred embodiment the channels are additionally open toward the second side of the surface-structuring mold, and are continuous between the first and second side, and permit fluid exchange between the first side and the second side of the surface-structuring mold.

The present invention therefore also provides a process in which the channels are additionally open toward the second side, and are continuous between the first side and the second side and permit fluid exchange between the first side and the second side of the surface-structuring mold.

It is self-evident that when fluid exchange is possible between the first side and the second side of the surface-structuring mold via the channels, gas exchange is also possible between the first side and the second side of the surface-structuring mold via the channels.

In one embodiment that is in particular preferred of the surface-structuring mold of the invention, fluid exchange is possible between the first side of the surface-structuring mold and the environment on the second side of the surface-structuring mold via the channels.

The present invention therefore also provides a process in which the channels are additionally open toward the second side, and are continuous between the first side and the second side, and permit fluid exchange between the first side of the surface-structuring mold and the environment on the second side of the surface-structuring mold.

For the purposes of the present invention, the expression “fluids” means both gases and liquids. For the purposes of the present invention, if the channels permit fluid exchange between the first side and the second side of the surface-structuring mold, this therefore means that an exchange of gases and liquids is possible between the first side and the second side of the surface-structuring mold via the channels.

The channels can have any desired cross section. They can by way of example have a polygonal, round, or oval cross section. It is preferable that the channels have a round or oval cross section.

It is preferable that the length of the channels is in the range from 10 μm to 5 mm, particularly in the range from 10 μm to 1 mm, and in particular in the range from 10 μm to 500 μm.

The diameter of the channels is generally in the range from 0.1 to 50 μm, preferably in the range from 1 to 20 μm, and particularly preferably in the range from 1 to 10 μm. With particular preference the channels are isoporous. For the purposes of the present invention, “isoporous” means that all channels have an equal diameter. For the purposes of the present invention, the expression “equal diameter” means that the diameter of the channels differs among these by at most +/−20%, preferably by at most +/−10%, and with particular preference by at most +/−5%.

The present invention therefore also provides a process in which the diameter of the channels of the surface-structuring mold is in the range from 0.1 to 50 μm.

The average distance between the channels is usually in the range from 1.5× average diameter of the channels to 10× average diameter of the channels, preferably in the range from 2× average diameter of the channels to 5× average diameter of the channels.

The expression “average diameter of the channels” means the diameter of the channels averaged over all of the channels of the surface-structuring mold. Relevant methods are known to the person skilled in the art.

The diameter of the individual channels is determined for channels that have a cross section differing from the round shape by taking an average over the various diameters. For example, the diameter of a channel with an oval cross section is determined by the smallest and the greatest diameters of the channel being determined and the average value of these diameters then being calculated in order to determine the diameter of the channel. Relevant methods are known to the person skilled in the art.

The average distance between the channels is defined as the average distance between the center of a first channel and the center of all of the other channels.

The average distance between the channels can be determined by evaluating the radial distribution function of the channels. For a two-dimensional arrangement of the channels, the radial distribution function is defined as

dn(r)=N/A·g(r)·2 πr·dr, where

dn(r) is the number of channels located within an interval dr at a distance r from the first channel.

N/A is the average density of channels, i.e. the number N of channels per unit of area A.

The number of channels in the surface-structuring mold is preferably in the range from 500 to 10 000 000 channels per mm², and particularly preferably in the range from 10 000 to 1 000 000 channels per mm².

The function g(r) can be determined by using image analysis to evaluate a micrograph of the surface-structuring mold. The function g(r) is defined as

$$g ( r ) = \frac{1}{N} 〈 {\sum }_{j \neq k}^{N} δ ( r - \sqrt{{( {x}_{i} - {x}_{j} )}^{2} + {( {y}_{i} - {y}_{j} )}^{2}} ) 〉$$

N here is the number of channels per unit of area A.

x_{i,} and yᵢ are the coordinates of the ith channel.

xⱼ, and yⱼ are the coordinates of the jth channel,

Methods for evaluating the abovementioned functions are known to the person skilled in the art.

The average distance between the channels is by way of example in the range from 0.2 μm to 50 μm, preferably in the range from 1 μm to 10 μm.

The surface-structuring mold can have been produced from any of the materials known to the person skilled in the art that are suitable as surface-structuring mold. By way of example, the surface-structuring mold can have been produced from a metal, a metal alloy, a ceramic, glass, silicon, a polymer, or else a mixture thereof.

It is self-evident that if the surface-structuring mold comprises a polymer, the glass transition temperature and melting point of the polymer are higher than those of the at least one polymer comprised in the polymeric material.

Suitable metals from which the surface-structuring mold can have been produced are by way of example selected from the group consisting of iron, steel, nickel, aluminum, titanium, copper, gold, silver, platinum, and palladium. Suitable metal alloys are by way of example selected from the group consisting of bronze, brass, and nickel silver.

Suitable polymers from which the surface-structuring mold can have been produced are by way of example polymers selected from the group consisting of polycarbonates, polydimethylsiloxane, polyamides, polyim ides, polyvinylidene fluoride, polytetrafluoroethylene, polyether ketones, and polysulfones.

The present invention therefore also provides a process in which the surface-structuring mold has been produced from a metal, a metal alloy, a ceramic, glass, silicon, or a polymer.

If the surface-structuring mold comprises mixtures of a metal, of a metal alloy, of a ceramic, glass, or silicon, or of a polymer, the surface-structuring mold can comprise a homogeneous mixture of the materials. It is equally possible that the surface-structuring mold has by way of example been produced from metal and is then coated with a polymer.

Step i)

In step i) the polymeric material is provided. Methods for the provision of polymeric materials are known per se to the person skilled in the art. The polymeric material can by way of example be provided via extrusion, casting, doctoring, spraying, calendering, compression molding, or blow molding.

The polymeric material can by way of example be provided in the form of rolls or of sheets.

The polymeric material can be provided in step i) at any desired temperature below the decomposition temperature of the polymer comprised in the polymeric material. It is preferable that the polymeric material is provided at the temperature at which the step ii) is carried out. It is moreover preferable that the polymeric material is provided at a temperature lower than that of step ii), and that the polymeric material is not heated to the appropriate temperature before step ii).

The temperature during step i) is therefore generally in the range from −30 to 350° C., preferably in the range from 0 to 100° C., and with particular preference in the range from 10 to 40° C.

Step ii)

In step ii) the polymeric material provided in step i) is brought into contact with the first side of the surface-structuring mold. Step ii) is carried out at ambient pressure.

Processes for bringing the polymeric material into contact with the surface-structuring mold are known to the person skilled in the art. By way of example, the polymeric material can be brought into contact with the surface-structuring mold in that the surface-structuring mold is placed onto the polymeric material. Equally it is possible that the polymeric material is placed onto the surface-structuring mold. It is moreover possible by way of example to pass the surface-structuring mold over the polymer in such a way that the surface-structuring mold and the polymeric material come into contact with one another.

The expression “ambient pressure” means the pressure in the region surrounding the polymeric material and the surface-structuring mold. The ambient pressure is usually in the range from 600 to 1100 mbar, preferably in the range from 800 to 1100 mbar, and with particular preference in the range from 950 to 1050 mbar.

Other terms used for the ambient pressure are air pressure and atmospheric pressure.

In other words, step ii) is not carried out in vacuo. The polymeric material provided in step i) is therefore not brought into contact in vacuo with the first side of the surface-structuring mold.

The present invention therefore also provides a process in which step ii) is not carried out in vacuo.

It is preferable that in step ii) the polymeric material is brought into contact at a first temperature T₁ with the first side of the surface-structuring mold. The first temperature T₁ is usually above the glass transition temperature T_{G} of the at least one polymer comprised in the polymeric material, and with particular preference the first temperature T₁ is above the melting point T_{M} of the at least one polymer comprised in the polymeric material.

The present invention therefore also provides a process in which the polymeric material comprises at least one polymer with glass transition temperature T_{G} and, in step ii), the polymeric material is brought into contact at a first temperature T₁, which is above the last transition temperature T_{G} of the at least one polymer, with the first side of the surface-structuring mold.

The first temperature T₁ at which, in step ii), the polymeric material is brought into contact with the first side of the surface-structuring mold is usually above the glass transition temperature T_{G}, preferably the melting point T_{M} of the at least one polymer comprised in the polymeric material, by at least 1° C., preferably at least 5° C., and with particular preference at least 10° C.

The first temperature T₁, at which the polymeric material in step ii) is brought into contact with the first side of the surface-structuring mold, is usually below the decomposition temperature of the at least one polymer comprised in the polymeric material.

It is preferable that the first temperature T₁ in step ii) is in the range from 50 to 350° C., particularly in the range from 80 to 280° C., and most preferably in the range from 120 to 220° C.

The polymeric material can be brought to the first temperature T₁ while it is brought into contact with the surface-structuring mold in step ii). It is equally possible that the polymeric material is already provided at this first temperature T₁ in step i).

In step ii), the polymeric material is brought into contact with the first side of the surface-structuring mold with an application pressure in the range from 0 to 25 kPa, preferably in the range from 0 to 10 kPa, and with particular preference in the range from 0 to 5 kPa. It is most preferable that no application pressure is used when, in step ii), the polymeric material is brought into contact with the first side of the surface-structuring mold. For the purposes of the present invention, the expression “no application pressure” means that the application pressure is at most 0.5 kPa, preferably at most 0.1 kPa, and most preferably at most 0.05 kPa.

The present invention therefore also provides a process in which, in step ii), the polymeric material is brought into contact with the first side of the surface-structuring mold with an application pressure in the range from 0 to 25 kPa.

If application pressure is used when the polymeric material is brought into contact with the first side of the surface-structuring mold, this can be generated by any of the methods known to the person skilled in the art. By way of example, it can be generated in that, in step ii), the surface-structuring mold and/or the polymeric material is loaded with a weight, or in that hydraulic, electromechanical, compressed-air-operated, or purely mechanical presses are used, or in that by way of example during step ii) when the surface-structuring mold and the polymeric material are brought into contact they are passed through rollers or rolls in such a way as to generate application pressure.

It is self-evident that for the purposes of the present invention the application pressure differs from the ambient pressure.

In another preferred embodiment the polymeric material is brought into contact with the first side of the surface-structuring mold in step ii) for a time of at most 1 minute, preferably at most 20 seconds, and with particular preference at most 10 seconds.

The time during which the polymeric material is brought into contact, in step ii), with the first side of the surface-structuring mold is usually at least 1 second, preferably at least 2 seconds, and with particular preference at least 5 seconds.

The present invention therefore also provides a process in which, in step ii), the polymeric material is brought into contact with the first side of the surface-structuring mold for a time of at most one minute.

The term “contact time” is also used for the time during which the polymeric material is in contact in step ii) with the first side of the surface-structuring mold.

For the purposes of the present invention, the “contact time” is the time during which the polymeric material is brought into contact with the first side of the surface-structuring mold, and during which the first temperature T₁ in the regions of the polymeric material that are in direct contact with the mold is above the glass transition temperature T_{G}, preferably above the melting point T_{M} of the at least one polymer comprised in the polymeric material.

The present invention therefore also provides a process for the structuring of a surface of a polymeric material by a surface-structuring mold which comprises a first side and a second side, where the first side of the surface-structuring mold comprises channels open toward the first side, comprising the steps of:
I) provision of the polymeric material,
II) bringing the polymeric material provided in step I) into contact with the first side of the surface-structuring mold for a contact time of at most one minute,
III) removal of the surface-structuring mold from the polymeric material to give a structured surface on the polymeric material.

The descriptions and preferences described previously for the steps i) and ii) apply correspondingly to the steps I) and II) of this process. The descriptions and preferences described below for step iii) apply correspondingly to the step III) of this process.

Without any intention of restricting the present invention thereto, a possible theory is that during step ii) and, respectively, step II) capillary forces cause some of the at least one polymer comprised in the polymeric material to flow into the channels of the surface-structuring mold.

Step iii)

In step iii) the surface-structuring mold is removed from the polymeric material to give a structured surface on the polymeric material.

Any other methods known to the person skilled in the art can be used to remove the surface-structuring mold from the polymeric material. By way of example, the removal in step iii) can be achieved by pulling the polymeric material away from the surface-structuring mold, by pulling the surface-structuring mold away from the polymeric material, by etching to remove the surface-structuring mold, or by dissolving the surface-structuring mold. It is preferable that the surface-structuring mold is pulled away from the polymeric material, and/or that the polymeric material is pulled away from the surface-structuring mold.

The present invention therefore also provides a process in which, in step iii), the removal of the surface-structuring mold from the polymeric material is achieved in that the surface-structuring mold is pulled away from the polymeric material, and/or in that the polymeric material is pulled away from the surface-structuring mold.

Step iii) is usually carried out at a second temperature T₂. The second temperature T₂, at which the step iii) is carried out, is generally dependent on the method used to remove the surface-structuring mold from the polymeric material.

In one preferred embodiment the polymeric material is pulled away from the surface-structuring mold, and/or the surface-structuring mold is pulled away from the polymeric material. The second temperature T₂ is then preferably below the first temperature T₁ of step ii). It is preferable that the second temperature T₂ is above the glass transition temperature T_{G} and below the melting point T_{M} of the at least one polymer comprised in the polymeric material.

It is preferable that the second temperature T₂ during step iii) is in the range from −30 to 350° C., particularly in the range from 0 to 100° C., and in particular in the range from 10 to 60° C.

In another embodiment of the process of the invention, during step ii) and during step iii) fluid exchange via the channels is possible between the first side of the surface-structuring mold and the environment on the second side of the surface-structuring mold.

The present invention therefore also provides a process in which, during step ii), and during step iii), fluid exchange via the channels is possible between the first side of the surface-structuring mold and the environment on the second side of the surface-structuring mold.

The structured surface is obtained when the surface-structuring mold is removed from the polymeric material. The structured surface on the polymeric material usually has tiny hairs at locations on the surface of the polymeric material which were in contact with the channels comprised in the surface-structuring mold. The structured surface obtained in step iii) on the polymeric material therefore preferably comprises crinite structures which comprise a large number of tiny hairs.

The present invention therefore also provides a process in which the structured surface obtained in step iii) on the polymeric material comprises crinite structures which comprise a large number of tiny hairs.

For the purposes of the present invention, the expression “large number of tiny hairs” means by way of example from 500 to 10 000 000 tiny hairs per mm², and particularly preferably from 10 000 to 1 000 000 tiny hairs per mm².

Since, as described above, the structured surface on the polymeric material has tiny hairs at locations on the surface of the polymeric material which were in contact with the channels comprised in the surface-structuring mold, it is therefore clear to the person skilled in the art that the number of the tiny hairs per mm² on the structured surface on the polymeric material is in essence equal to the number of channels per mm²in the surface-structuring mold. For the purposes of the present invention, the expression “in essence equal to” means that the extent to which the number of the hairs per mm² on the structured surface is smaller than the number of channels per mm² in the surface-structuring mold is at most 50%, preferably at most 20%, and with particular preference at most 10%.

The expression “crinite structure” means that the ratio of the length of the tiny hairs of the crinite structures of the structured surface of the polymeric material to the diameter of the tiny hairs of the crinite structures of the structured surface of the polymeric material is in the range from 2 to 400, preferably in the range from 3 to 300, and particularly preferably in the range from 5 to 200.

The present invention therefore also provides a process in which the ratio of the length of the tiny hairs of the crinite structures of the structured surface of the polymeric material to the diameter of the tiny hairs of the crinite structures of the structured surface of the polymeric material is in the range from 2 to 400.

It is preferable that the length of the tiny hairs of the crinite structures of the structured surface of the polymeric material is in the range from 50 to 300 μm, particularly in the range from 50 to 200 μm.

The present invention therefore also provides a process in which the length of the tiny hairs of the crinite structures of the structured surface of the polymeric material is in the range from 50 to 300 μm.

It is preferable that the diameter of the tiny hairs of the crinite structures of the structured surface of the polymeric material is in the range from 0.1 to 50 μm, particularly in the range from 0.5 to 20 μm, and in particular in the range from 1 to 10 μm.

The present invention therefore also provides a process in which the diameter of the tiny hairs of the crinite structures of the structured surface of the polymeric material is in the range from 0.1 to 50 μm.

The length of the tiny hairs of the crinite structures, and the diameter of the tiny hairs of the crinite structures, can be determined by any of the methods known to the person skilled in the art. It is preferable that they are determined by evaluation of images obtained from optical microscopy or from electron microscopy.

If the tiny hairs of the crinite structures have a cross section differing from the round shape, for example if they therefore have an oval cross section, an average is taken over the various diameters. For example, in the case of a tiny hair with an oval cross section, the greatest and the smallest diameters are determined and then the average value of these two diameters are established and taken as the diameter of such a tiny hair.

For the purposes of the present invention, if the diameter of a tiny hair of the crinite structures varies over the length thereof, the diameter is determined with half the length of the tiny hair, that is to say half the height of the tiny hair.

In one particularly preferred embodiment the average length of the tiny hairs of the crinite structures is greater than the average length of the channels of the structuring mold. This is in particular the case when the structured surface of the polymeric material is produced by pulling the surface-structuring mold away from the polymeric material, and/or by pulling the polymeric material away from the surface-structuring mold.

It is moreover preferable that the average diameter of the tiny hairs of the crinite structures is smaller than the average diameter of the channels of the surface-structuring mold. This is in particular the case when the structured surface of the polymeric material is produced by pulling the surface-structuring mold away from the polymeric material, and/or by pulling the polymeric material away from the surface-structuring mold.

The expression average diameter of the tiny hairs of the crinite structures means the diameter of the tiny hairs of the crinite structures averaged over all of the tiny hairs of the crinite structures of the polymeric material.

The expression average length of the tiny hairs of the crinite structures means the length of the tiny hairs of the crinite structures averaged over all of the tiny hairs of the crinite structures of the polymeric material.

The expression average diameter of the channels means the diameter of the channel averaged over all of the channels of the surface-structuring mold. Relevant methods are known to the person skilled in the art.

The expression average length of the channels means the length of the channel averaged over all of the channels of the surface-structuring mold. Relevant methods are known to the person skilled in the art.

The person skilled in the art is equally aware of methods for determining the average length of the tiny hairs of the crinite structures, and of the channels, and of methods for determining the average diameter of the tiny hairs of the crinite structures, and of the channels. A particularly suitable method uses scanning electron microscopy using secondary electron contrast on surfaces, and also on cross sections of the structured material.

The structured surfaces produced in the invention on the polymeric materials feature high hydrophobicity.

Key

a Thickness of surface-structuring mold

b Length of channels

c Diameter of channels

d Distance between the centers of two channels

1 First side

2 Second side

3 Channel

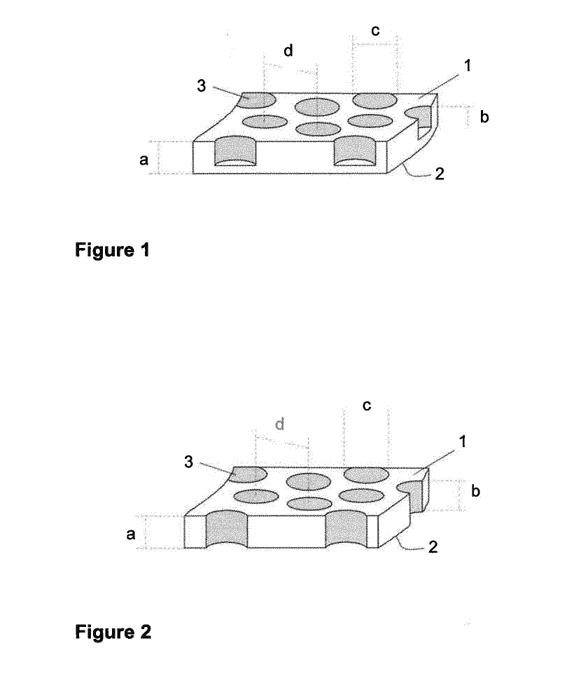

FIG. 1 shows a surface-structuring mold of the invention with a first side 1, where the first side 1 comprises channels 3 of length b, open toward the first side 1. The channels 3 are closed toward the second side 2. When the second side 2 of the surface-structuring mold is non-porous, the thickness a of the surface-structuring mold is greater than the length b of the channels 3.

FIG. 2 shows another surface-structuring mold of the invention with a first side 1, where the surface-structuring mold comprises channels 3 open toward the first side 1 and toward the second side 2. The channels 3 therefore permit fluid exchange between the first side 1 and the second side 2. The length b of the channels 3 is by way of example the same as the thickness a of the surface-structuring mold when the arrangement has the channels 3 perpendicular to the first side 1 and perpendicular to the second side 2.

The examples below provide further explanation of the process of the invention, but said process is not restricted thereto.

### EXAMPLES

Polymeric Material

A polyethylene film (HDPE film) of thickness 500 μm was provided by pressing HDPE polymer pellets between two heated press platens at 150° C. for 5 minutes in a press mask of thickness 500 μm. After a press phase lasting 5 minutes with a 20 kN load the platens were cooled in the press, and the resultant HDPE film was removed once a temperature close to room temperature had been reached.

A polyethylene film (LDPE film) of thickness about 200 μm was used, as is obtainable commercially from Goodfellow.

A polypropylene film (PP film) of thickness 500 μm was provided by, in a manner analogous to that for the HDPE film, melting Moplen HP 400 H pellets (LyondeliBasell Industries Holdings) between two heated press platens at 220° C. for 5 minutes in a press mask of thickness 500 μm. After a press phase lasting 5 minutes with a 20 kN load the platens were cooled in the press, and the resultant PP film was removed once a temperature close to room temperature had been reached.

A polystyrene film (PS film) of thickness 500 μm was obtained by, in a manner analogous to that for the HDPE film, melting PS 158 K pellets (Styrolution) between two heated press platens at 190° C. for 5 minutes in a press mask of thickness 500 μm. After a press phase lasting 5 minutes with a 20 kN load the platens were cooled in the press, and the resultant PS film was removed once a temperature close to room temperature had been reached.

Sheet-Like Shaping Mold

Four different Isopore™ polycarbonate membranes of thickness in each case 20 μm and with average channel diameters of 0.6 μm, 1.2 μm, 3.0 μm, and 10 μm from Merck Millipore were used. The channels were continuous and open toward both sides.

Other systems used were a polycarbonate membrane with average channel diameters of 1 μm from Whatman, and a polycarbonate membrane with average channel diameters of 5 μm from Sterlitech. The thickness of the membranes was 20 μm, and the channels were continuous and open toward both sides.

Other systems used were nickel foils of thickness 14 μm with average channel diameters of 4 μm and with an average distance of 8 μm between the channels, and also a nickel foil of thickness 10 μm with channel diameters of 7 μm and an average distance of 11 μm between the channels from Temicon GmbH, Dortmund. The channels were continuous and open toward both sides.

Nickel foil was also used in the form of two-layer laminate with non-continuous pores and total thickness of 27 μm. The thickness of the shaping layer was 5 μm, with round channels (length of channels: 5 μm, average channel diameter: 1.5 μm, average distance between channels: 3 μm). The outer layer was likewise composed of nickel, thickness 22 μm, and had no pores.

Structured silicon wafer produced by microlithography. The total thickness of the surface-structuring mold was 500 μm. The channels were closed toward one side and had square cross section with edge length 8×8 μm. The average distance between the channels was 40 μm. The length of the channels was 20 μm.

Characterization

The morphology of the structured surfaces of the polymeric materials and of lateral views of cross sections of the polymeric materials was studied by means of scanning electron microscopy using secondary electron detection for topographic imaging. An ElectroScan 2020 ESEM was used here, and the acceleration voltage used was 23 kV. The images were obtained by gold-sputtering to render the surfaces of the polymeric materials conductive.

The wetting behavior of the resultant structured surfaces was determined by measuring the contact angle with water. A Dataphysics OCA20 goniometer was used for this purpose with water droplets of volume 10 μL. Droplets of lower volume could not be deposited on the extremely water-repellent structured surfaces. The angle at which the water droplets rolled off the structured surface was determined, this being the angle by which the polymeric material had to be inclined from horizontal to cause the droplet to move. The determination was achieved by increasing the angle of inclination stepwise, starting from a horizontal orientation with initial value 0°. All of the measurements were made at room temperature under ambient conditions. The stated values are in each case the average value of 5 measurements at various locations on the polymeric material.

### Inventive Example 1

### Structuring of an HDPE Film by Means of Polycarbonate Membranes, General Specification

The HDPE film (2×2 cm) was heated on a hotplate to 150° C., and the polycarbonate membrane was placed thereon under atmospheric pressure and loaded with a weight of 100 g. This corresponds to an application pressure of 2.5 kPa, After 15 s, the polymeric material, together with the surface-structuring mold, was removed from the hotplate and allowed to cool at room temperature (23° C.). When the temperature of the HDPE film was about 40° C., the membrane was pulled away manually from the HDPE film, and after cooling to room temperature the structured surface of the HDPE film was analyzed. Table 1 collates the analysis data.

TABLE 1

| | | | | Angle of | |
|---|---|---|---|---|---|
| | Diameter of | Diameter of | Length of crinite | contact with | Water roll-off |
| | channels | crinite structuring | structuring | water | angle |
| Example | (μm) | (μm) | (μm) | (degrees) | (degrees) |
| 1a | 0.6 | 0.5 | 84 | 163 | <10 |
| 1b | 1.0 | 0.8 | 65 | n.a.* | <5 |
| 1c | 1.2 | 0.7 | 69 | 150 | <10 |
| 1d | 3 | 1.0 | 110 | 158 | <10 |
| 1e | 5 | 4.0 | 32 | 151 | <10 |
| 1f | 10 | 10 | 16 | 160 | 15 |

*No determination possible, because it was impossible to retain the drop on the surface.

### Inventive Example 2

### Structuring of an LDPE Film by Means of Polycarbonate Membranes, General Specification

The LDPE film (2×2 cm) was heated on a hotplate to 140° C., and the polycarbonate membrane was placed thereon under atmospheric pressure and loaded with a weight of 100 g. This corresponds to an application pressure of 2.5 kPa. After 40 s, the polymeric material, together with the surface-structuring mold, was removed from the hotplate and allowed to cool at room temperature (23° C.). When the temperature of the LDPE film was about 40° C., the membrane was pulled away manually from the LDPE film, and after cooling to room temperature the structured surface of the LDPE film was analyzed. Table 2 collates the analysis data.

TABLE 2

| | Diameter | Diameter | Length of | Angle of | Water |
|---|---|---|---|---|---|
| | of | of crinite | crinite | contact with | roll-off |
| | channels | structuring | structuring | water | angle |
| Example | (μm) | (μm) | (μm) | (degrees) | (degrees) |
| 2a | 0.6 | 0.5 | 12 | 144 | 15 |
| 2b | 1.2 | 1.0 | 11 | 140 | 15 |
| 2c | 3 | 2.5 | 11 | 142 | 15 |
| 2d | 10 | 9 | 3 | 103 | n.a.** |

**No determination possible; even at an angle of inclination of 90°, droplet adheres on the surface.

### Inventive Example 3

### Modification of an Polypropylene Film by Means of Polycarbonate Membranes, General Specification

The PP film (2×2 cm) was heated on a hotplate to 190° C., and the polycarbonate membrane was placed thereon under atmospheric pressure, without weight loading. After 5 s, the polymeric material, together with the surface-modification mold, was removed from the hotplate and allowed to cool at room temperature (23° C.). When the temperature of the PP film was about 40° C., the membrane was pulled away manually from the PP film, and after cooling to room temperature the structured surface of the PP film was analyzed. Table 3 collates the analysis data.

TABLE 3

| | Diameter | Diameter | Length of | Angle of | Water |
|---|---|---|---|---|---|
| | of | of crinite | crinite | contact with | roll-off |
| | channels | structuring | structuring | water | angle |
| Example | (μm) | (μm) | (μm) | (degrees) | (degrees) |
| 3a | 0.6 | 0.4 | 20 | 165 | <10 |
| 3b | 1.2 | 0.6 | 10 | n.a.* | <5 |
| 3c | 3 | 1.7 | 7 | 163 | <10 |
| 3d | 10 | 9.4 | 5 | 119 | n.a.** |

*No determination possible, because it was impossible to retain the drop on the surface.
**No determination possible; even at an angle of inclination of 90°, droplet adheres on the surface.

### Inventive Example 4

### Structuring of a PP Film by Means of a Nickel Foil, General Specification

The PP film (2×2 cm) was heated on a hotplate to 190° C., and the nickel foil was placed thereon under atmospheric pressure and loaded with a weight of 100 g. This corresponds to an application pressure of 2.5 kPa. After 60 s, the polymeric material, together with the surface-structuring mold, was removed from the hotplate and allowed to cool at room temperature (23° C.). When the temperature of the PP film was about 40° C., the nickel foil was pulled away manually from the PP film, and after cooling to room temperature the structured surface of the PP film was analyzed. Table 4 collates the analysis data.

TABLE 4

| | Diameter | Diameter | Length of | Angle of | Water |
|---|---|---|---|---|---|
| | of | of crinite | crinite | contact with | roll-off |
| | channels | structuring | structuring | water | angle |
| Example | (μm) | (μm) | (μm) | (degrees) | (degrees) |
| 4 | 4 | 4 | 10 | 150 | 20 |

### Inventive Example 5

### Structuring of an HDPE Film by Means of a Nickel Foil, General Specification

The HDPE film (2×2 cm) was heated on a hotplate to 150° C., and the nickel foil was placed thereon under atmospheric pressure and loaded with a weight of 100 g. This corresponds to an application pressure of 2.5 kPa. After 15 s, the polymeric material, together with the surface-structuring mold, was removed from the hotplate and allowed to cool at room temperature (23° C.). When the temperature of the HDPE film was about 40° C., the nickel foil was pulled away manually from the HDPE film, and after cooling to room temperature the structured surface of the HDPE film was analyzed. Table 5 collates the analysis data.

TABLE 5

| | Diameter | Diameter | Length of | Angle of | Water |
|---|---|---|---|---|---|
| | of | of crinite | crinite | contact with | roll-off |
| | channels | structuring | structuring | water | angle |
| Example | (μm) | (μm) | (μm) | (degrees) | (degrees) |
| 5a | 4 | 4 | 10 | 140 | 30 |
| 5b | 7 | 7 | 14 | 135 | 65 |

### Inventive Example 6

### Structuring of a PS Film by Means of a Nickel Foil, General Specification

The PS film (2×2 cm) was heated on a hotplate to 230° C., and the nickel foil was placed thereon under atmospheric pressure and loaded with a weight of 100 g, corresponding to an application pressure of 2.5 kPa. After 60 s, the polymeric material, together with the surface-structuring mold, was removed from the hotplate and allowed to cool at room temperature (23° C.). When the temperature of the PS film was about 40° C., the nickel foil was pulled away manually from the PS film, and after cooling to room temperature the structured surface of the PS film was analyzed. Table 6 collates the analysis data.

TABLE 6

| | Diameter | Diameter | Length of | Angle of | Water |
|---|---|---|---|---|---|
| | of | of crinite | crinite | contact with | roll-off |
| | channels | structuring | structuring | water | angle |
| Example | (μm) | (μm) | (μm) | (degrees) | (degrees) |
| 6 | 4 | 4 | 12 | 165 | 10 |

### Inventive Example 7

### Structuring of a Polymer Film by Means of Polycarbonate Membranes, and then Removal of the Membrane by Means of Solvent

The polymeric materials (2×2 cm) were heated on a hotplate. The HDPE film was heated to 150° C., and the PP film was heated to 190° C. The polycarbonate membrane was placed thereon at atmospheric pressure, and in the case of the HDPE film loaded with a weight of 100 g, corresponding to an application pressure of 2.5 kPa; no weight loading was used in the case of the PP film. After 15 s (HDPE film) or after 5 s (PP film) the polymeric materials, together with the surface-structuring mold, were removed from the hotplate and cooled to 23° C. The polymeric materials, together with the polycarbonate membrane, were then immersed in dichloromethane as solvent, whereupon the polycarbonate membrane dissolved. After complete removal of the polycarbonate, the PE film or the PP film was dried, and the structured surfaces of the polymeric materials were analyzed. Table 7 collates the analysis data.

TABLE 7

| | | | Diameter of | Length of | Angle of | Water |
|---|---|---|---|---|---|---|
| | | Diameter of | crinite | crinite | contact | roll-off |
| | | channels | structuring | structuring | with water | angle |
| Example | Polymer | (μm) | (μm) | (μm) | (degrees) | (degrees) |
| 7a | HDPE | 0.6 | 0.6 | 9 | 177 | <10 |
| 7b | HDPE | 1.2 | 1.2 | 11 | n.a.* | <5 |
| 7c | HDPE | 3 | 3 | 14 | 168 | 10 |
| 7d | HDPE | 5 | 5 | 10 | 109 | n.a.** |
| 7e | HDPE | 10 | 10 | 17 | 117 | n.a.** |
| 7f | PP | 0.6 | 0.6 | 3.5 | 160 | 10 |
| 7g | PP | 1.2 | 1.2 | 3.8 | 170 | 10 |
| 7h | PP | 3 | 3 | 3.6 | 150 | n.a.** |
| 7i | PP | 5 | 5 | 5.2 | 108 | n.a.** |
| 7j | PP | 10 | 10 | 5.1 | 106 | n.a.** |

*No determination possible, because it was impossible to retain the drop on the surface.
**No determination possible; even at an angle of inclination of 90°, droplet adheres on the surface.

### Comparative Example 8

### Structuring of an HDPE Film by Means of a Nickel Foil with Channel Length 5 μm

The HDPE film (2×2 cm) was heated at atmospheric pressure on a hotplate to 150° C., and the nickel foil was placed thereon and loaded with a weight of 100 g. This corresponds to an application pressure of 2.5 kPa. After 15 s, the polymeric material, together with the surface-structuring mold, was removed from the hotplate and allowed to cool at room temperature (23° C.). When the temperature of the HDPE film was about 40° C., the nickel foil was pulled away manually from the HDPE film, and after cooling to room temperature the structured surface of the HDPE film was analyzed. It was not possible to obtain any structures of the invention on the surface.

### Inventive Example 9

### Structuring of an HDPE Film by Means of a Structured Silicon Wafer with Channel Length 20 μm

The HDPE film (2×2 cm) was heated on a hotplate to 150° C., and the structured silicon wafer was placed thereon under atmospheric pressure and loaded with a weight of 100 g, corresponding to an application pressure of 2.5 kPa. After 15 s, the polymeric material, together with the surface-structuring mold, was removed from the hotplate and allowed to cool at room temperature (23° C.). When the temperature of the HDPE film was about 40° C., the surface-structuring mold was pulled away manually from the HDPE film, and after cooling to room temperature the structured surface of the HDPE film was analyzed. Crinite structures of the invention were obtained on the structured surface. The average length of the crinite structures was 40 μm. The angle of contact with water on the structured surface was determined as 160°, and the roll-off angle was 5°. The average diameter of the tiny hairs, determined by scanning electron microscopy and measurement of the tiny hairs on the scaled micrographs, was 0.9 μm.

1.-16. (canceled)

17. A process for structuring of a surface of a polymeric material by a surface-structuring mold which comprises a first side and a second side, where the first side of the surface-structuring mold comprises channels of length at least 10 ₗam open toward the first side, comprising the steps of:
i) providing the polymeric material,
ii) bringing the polymeric material provided in step i) into contact with the first side of the surface-structuring mold,
iii) removing the surface-structuring mold from the polymeric material to give a structured surface on the polymeric material,
where the step ii) is carried out at ambient pressure,
where the ambient pressure is in the range from 600 to 1100 mbar,
where the polymeric material comprises at least one polymer with glass transition temperature T_{G} and, in step ii), the polymeric material is brought into contact at a first temperature T₁, which is above the last transition temperature T_{G} of the at least one polymer, with the first side of the surface-structuring mold, and
where the polymeric material is brought into contact with the first side of the surface-structuring mold with an application pressure in the range from 0 to 25 kPa.

18. The process according to claim 17, wherein the channels are additionally open toward the second side, and are continuous between the first side and the second side, and permit fluid exchange between the first side and the second side of the surface-structuring mold.

19. The process according to claim 17, wherein the polymeric material comprises at least one polymer selected from the group consisting of polyethylene, polypropylene, polystyrene, copolymers of polystyrene, polyesters, polyamides, polycarbonates, and polyurethane.

20. The process according to claim 17, wherein, in step ii), the polymeric material is brought into contact with the first side of the surface-structuring mold for a time of at most one minute.

21. The process according to claim 17, wherein the thickness of the material provided in step i) is in the range from 30 μm to 100 mm.

22. The process according to claim 17, wherein the structured surface obtained in step iii) on the polymeric material comprises crinite structures which comprise a large number of tiny hairs.

23. The process according to claim 22, wherein the length of the tiny hairs of the crinite structures of the structured surface of the polymeric material is in the range from 50 to 300 μm.

24. The process according to claim 22, wherein the diameter of the tiny hairs of the crinite structures of the structured surface of the polymeric material is in the range from 0.1 to 50 μm.

25. The process according to claim 22, wherein the ratio of the length of the tiny hairs of the crinite structures of the structured surface of the polymeric material to the diameter of the tiny hairs of the crinite structures of the structured surface of the polymeric material is in the range from 2 to 400.

26. The process according to claim 18, wherein, during step ii), and during step iii), fluid exchange via the channels is possible between the first side of the surface-structuring mold and the environment on the second side of the surface-structuring mold.

27. The process according to claim 17, wherein the first side of the surface-structuring mold is opposite to the second side of the surface-structuring mold.

28. The process according to claim 17, wherein the diameter of the channels of the surface-structuring mold is in the range from 0.1 to 50 μm.

29. The process according to claim 17, wherein the surface-structuring mold has been produced from a metal, a metal alloy, a ceramic, glass, silicon, or a polymer.

30. A process for structuring of a surface of a polymeric material by a surface-structuring mold which comprises a first side and a second side, where the first side of the surface-structuring mold comprises channels open toward the first side, comprising the steps of:
I) providing the polymeric material,
II) bringing the polymeric material provided in step I) into contact with the first side of the surface-structuring mold for a contact time of at most one minute,
III) removing the surface-structuring mold from the polymeric material to give a structured surface on the polymeric material.
